(19) United States
(12) Patent Application Publication
(10) Pub. No.: US 2024/0375652 A1
(43) Pub. Date: Nov. 14, 2024

(54) TRAVEL CONTROLLER AND METHOD FOR CONTROLLING TRAVEL

(71) Applicant: Toyota Jidosha Kabushiki Kaisha, Toyota-shi (JP)

(72) Inventor: Kenta Kumazaki, Tokyo-to (JP)

(73) Assignee: Toyota Jidosha Kabushiki Kaisha, Toyota-shi (JP)

(21) Appl. No.: 18/582,117

(22) Filed: Feb. 20, 2024

(30) Foreign Application Priority Data
May 9, 2023 (JP) 2023-077376

(51) Int. Cl. B60W 30/14; B60W 50/00; G06V 10/82; G06V 20/56

(52) U.S. Cl. CPC B60W 30/143; B60W 50/0097; G06V 10/82; G06V 20/56; B60W 2420/403; B60W 2520/125

(57) ABSTRACT

A travel controller generates a candidate parameter set including one or more parameters for controlling travel of a vehicle by inputting input data including a surroundings image into a classifier that has been trained to output the one or more parameters in response to input of the input data. The travel controller predicts a future motion of the vehicle under control of travel with the candidate parameter set. The travel controller controls travel of the vehicle, with the candidate parameter set when the future motion of the vehicle predicted for the candidate parameter set does not correspond to any of one or more undesirable motions of the vehicle, and without the candidate parameter set when the future motion of the vehicle predicted for the candidate parameter set corresponds to one of the one or more undesirable motions.

### FIELD

The present disclosure relates to a travel controller and a method for controlling travel of a vehicle.

### BACKGROUND

A travel controller controls travel of a vehicle by autonomous driving so as to keep at least a predetermined distance from objects around the vehicle, such as other vehicles and pedestrians. The travel controller controls travel of the vehicle appropriately by executing processes including recognition of surrounding objects, prediction of future positions of the surrounding objects, generation of a trajectory to be traveled, and identification of operating parameters of a travel mechanism for travel along the trajectory.

In recent years, attention has been given to a travel controller that controls travel of a vehicle with a machine learning model (end-to-end learning model) trained so as to output operating parameters of a travel mechanism, based on surroundings data representing the surroundings of the vehicle. An end-to-end learning model can be trained, using surroundings data and operating parameters at the time of manual driving as training data, more efficiently than machine learning models applied to individual processes. Japanese Unexamined Patent Publication No. 2019-153277 describes an autonomous vehicle driving system using an end-to-end learning model.

### SUMMARY

Since an end-to-end learning model outputs operating parameters based on surroundings data, a motion of a vehicle controlled with the outputted operating parameters may be inappropriate for this vehicle. For example, a sporty motion (e.g., a motion with a relatively large absolute value of acceleration in a travel direction of a vehicle or a relatively large steering angle) caused by operating parameters outputted by an end-to-end learning model is inappropriate for a vehicle of a luxury class, for which a milder motion is expected. Further, an end-to-end learning model trained with training data obtained on a road where appropriate manual control of travel is not easy, for example, because of its complex shape may output operating parameters that cause an inappropriate motion.

It is an object of the present disclosure to provide a travel controller that can control motion of a vehicle appropriately.

The following is a summary of the present disclosure.
(1) A travel controller including:
a memory configured to store one or more undesirable motions of a vehicle that are to be avoided; and
a processor configured to
   generate a candidate parameter set including one or more parameters for controlling travel of the vehicle by inputting input data into a classifier that has been trained to output the one or more parameters in response to input of the input data, the input data including a surroundings image obtained by a camera configured to take pictures of surroundings of the vehicle,
   predict a future motion of the vehicle under control of travel with the candidate parameter set,
   control travel of the vehicle with the candidate parameter set when the future motion of the vehicle predicted for the candidate parameter set does not correspond to any of the one or more undesirable motions, and
   control travel of the vehicle without the candidate parameter set when the future motion of the vehicle predicted for the candidate parameter set corresponds to one of the one or more undesirable motions.
(2) The travel controller according to item (1), wherein
the processor generates candidate parameter sets each including the one or more parameters, in the generation, and
in the case where the future motion of the vehicle predicted for at least one of the generated candidate parameter sets corresponds to one of the one or more undesirable motions, and where the future motion of the vehicle predicted for the other candidate parameter sets does not correspond to any of the one or more undesirable motions, the processor controls travel of the vehicle with one of the other candidate parameter sets, in the control of travel.
(3) A method for controlling travel executed by a travel controller configured to control travel of a vehicle, the method including:
generating a candidate parameter set including one or more parameters for controlling travel of the vehicle by inputting input data into a classifier that has been trained to output the one or more parameters in response to input of the input data, the input data including a surroundings image obtained by a surroundings imaging unit configured to take pictures of surroundings of the vehicle;
predicting a future motion of the vehicle under control of travel with the candidate parameter set;
controlling travel of the vehicle with the candidate parameter set when the future motion of the vehicle predicted for the candidate parameter set does not correspond to any of one or more undesirable motions of the vehicle that are to be avoided, the undesirable motions being stored in a storage unit; and
controlling travel of the vehicle without the candidate parameter set when the future motion of the vehicle predicted for the candidate parameter set corresponds to one of the one or more undesirable motions.
(4) A non-transitory computer-readable medium storing a computer program for controlling travel, the computer program causing a computer mounted on a vehicle to execute a process including:
generating a candidate parameter set including one or more parameters for controlling travel of the vehicle by inputting input data into a classifier that has been trained to output the one or more parameters in response to input of the input data, the input data including a surroundings image obtained by a surroundings imaging unit configured to take pictures of surroundings of the vehicle;
predicting a future motion of the vehicle under control of travel with the candidate parameter set;
controlling travel of the vehicle with the candidate parameter set when the future motion of the vehicle predicted for the candidate parameter set does not correspond to any of one or more undesirable motions of the vehicle that are to be avoided, the undesirable motions being stored in a storage unit; and
controlling travel of the vehicle without the candidate parameter set when the future motion of the vehicle predicted for the candidate parameter set corresponds to one of the one or more undesirable motions.

The travel controller according to the present disclosure can control motion of a vehicle appropriately.

### BRIEF DESCRIPTION OF DRAWINGS

FIG. 1 schematically illustrates the configuration of a vehicle equipped with a travel controller.

FIG. 2 schematically illustrates the hardware of the travel controller.

FIG. 3 illustrates an example of an undesirable motion list stored in a memory.

FIG. 4A schematically illustrates a situation where a first undesirable motion is detected, FIG. 4B is a graph indicating the first undesirable motion, and FIG. 4C is a graph of a parameter corresponding to the first undesirable motion.

FIG. 5A schematically illustrates a situation where a second undesirable motion is detected, FIG. 5B is a graph indicating the second undesirable motion, and FIG. 5C is a graph of a parameter corresponding to the second undesirable motion.

FIG. 6 is a functional block diagram of a processor included in the travel controller.

FIG. 7 is a flowchart of a travel control process.

### DESCRIPTION OF EMBODIMENTS

A travel controller that can control motion of a vehicle appropriately will now be described in detail with reference to the attached drawings. The travel controller stores one or more undesirable motions of a vehicle that are to be avoided, in a storage unit. The travel controller generates a candidate parameter set including one or more parameters for controlling travel of the vehicle by inputting, into a classifier, input data including a surroundings image obtained by a surroundings imaging unit configured to take pictures of surroundings of the vehicle. The classifier has been trained to output the one or more parameters for controlling travel of the vehicle in response to input of the input data. The travel controller predicts a future motion of the vehicle under control of travel with the candidate parameter set. When the future motion of the vehicle predicted for the candidate parameter set does not correspond to any of the one or more undesirable motions, the travel controller controls travel of the vehicle with the candidate parameter set. When, on the other hand, the future motion of the vehicle predicted for the candidate parameter set corresponds to one of the one or more undesirable motions, the travel controller controls travel of the vehicle without the candidate parameter set.

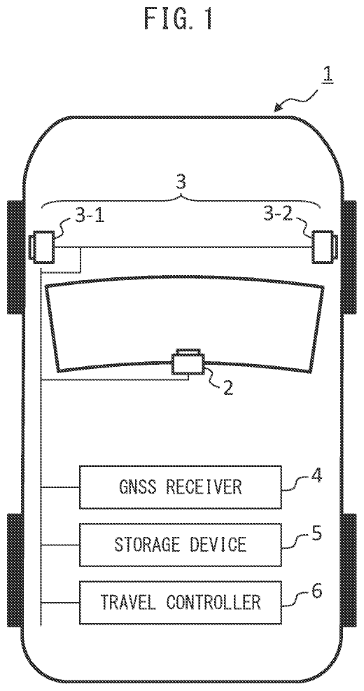

FIG. 1 schematically illustrates the configuration of a vehicle equipped with the travel controller.

The vehicle 1 includes a front camera 2, side sensors 3, a global navigation satellite system (GNSS) receiver 4, a storage device 5, and a travel controller 6. The front camera 2, the side sensors 3, the GNSS receiver 4, and the storage device 5 are communicably connected to the travel controller 6 via an in-vehicle network conforming to a standard such as a controller area network.

The front camera 2 is an example of the surroundings imaging unit configured to take pictures of surroundings of the vehicle 1. The front camera 2 includes a two-dimensional detector constructed from an array of optoelectronic transducers, such as CCD or C-MOS, having sensitivity to visible light and a focusing optical system that forms an image of a target region on the two-dimensional detector. The front camera 2 is mounted, for example, in a front upper area in the vehicle interior and oriented forward. The front camera 2 takes pictures of the surroundings of the vehicle 1 through a windshield every predetermined capturing period (e.g., 1/30 to 1/10 seconds), and outputs data representing the surroundings of the vehicle 1 as a surroundings image.

The side sensors 3, which are examples of a condition sensor configured to generate condition data for identifying the situation around the vehicle 1, includes a left light-detection-and-ranging (LiDAR) sensor 3-1 mounted on the left of the vehicle 1 and a right LiDAR sensor 3-2 mounted on the right of the vehicle 1. The left LiDAR sensor 3-1 and the right LiDAR sensor 3-2 each include a laser that generates infrared laser light and a light receiver that two-dimensionally scans laser light reflected by an object and received through an optical window. The light receiver measures the time until laser light radiated and reflected by an object is received, thereby generating a depth map whose pixels each have a value depending on the distance to an object represented in the pixel. The left LiDAR sensor 3-1 and the right LiDAR sensor 3-2 each output a depth map indicating the distance to an object beside the vehicle 1 every predetermined capturing period (e.g., 1/30 to 1/10 seconds). Each depth map outputted by the left LiDAR sensor 3-1 and the right LiDAR sensor 3-2 is an example of distance information indicating the distance to an object beside the vehicle 1.

The GNSS receiver 4, which is another example of the condition sensor, receives GNSS signals from GNSS satellites at predetermined intervals, and determines the position of the vehicle 1, based on the received GNSS signals. The GNSS receiver 4 outputs a positioning signal indicating the result of determination of the position of the vehicle 1 based on the GNSS signals to the travel controller 6 via the in-vehicle network at predetermined intervals.

The storage device 5, which is an example of the storage unit, includes, for example, a hard disk drive or a nonvolatile semiconductor memory. The storage device 5 stores map data including information on features such as lane lines in association with their positions.

The travel controller 6 stores one or more undesirable motions. The travel controller 6 generates a candidate parameter set, based on a surroundings image obtained by the front camera 2, and predicts a motion of the vehicle 1 under control of travel with the candidate parameter set. When the future motion of the vehicle predicted for the candidate parameter set does not correspond to any of the one or more undesirable motions, the travel controller 6 controls travel of the vehicle 1 with the candidate parameter set. However, when the future motion of the vehicle predicted for the candidate parameter set corresponds to one of the one or more undesirable motions, the travel controller 6 controls travel of the vehicle 1 without the candidate parameter set.

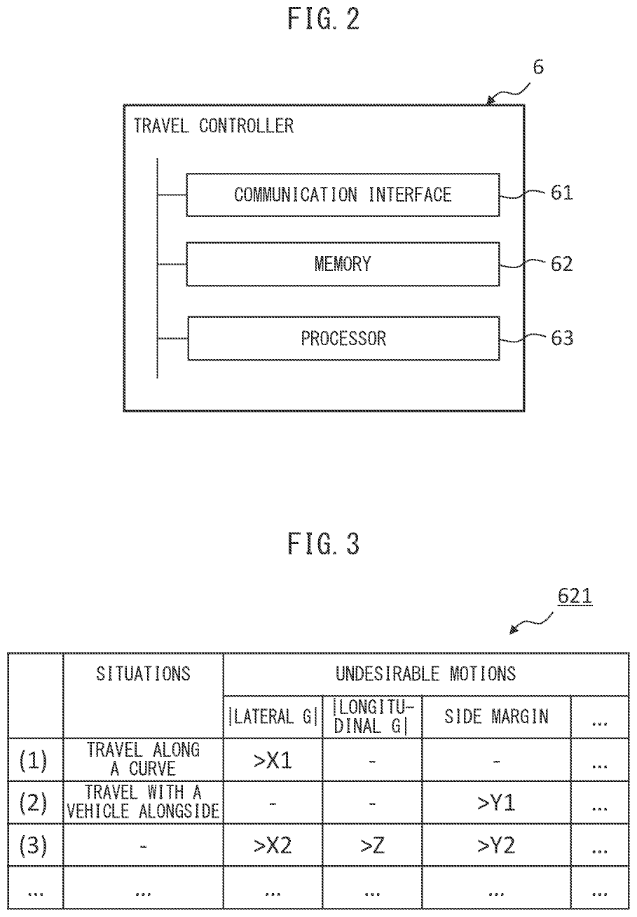

FIG. 2 schematically illustrates the hardware of the travel controller 6. The travel controller 6 includes a communication interface 61, a memory 62, and a processor 63.

The communication interface 61, which is an example of a communication unit, includes a communication interface circuit for connecting the travel controller 6 to the in-vehicle network. The communication interface 61 provides received data for the processor 63, and outputs data provided from the processor 63 to an external device.

The memory 62, which is another example of the storage unit, includes volatile and nonvolatile semiconductor memories. The memory 62 stores various types of data used for processing by the processor 63, e.g., one or more undesirable motions of the vehicle 1 that are to be avoided. A motion of the vehicle 1 in the present disclosure refers to an action of the vehicle 1 that can be observed from outside the vehicle 1. Examples of a motion of the vehicle 1 may include acceleration in the longitudinal direction (the travel direction of the vehicle 1), acceleration in the lateral direction (the right or left with respect to the travel direction of the vehicle 1), and a lateral space between an object in a surrounding area and the vehicle.

FIG. 3 illustrates an example of the undesirable motions stored in the memory 62. An undesirable motion table 621 illustrated in FIG. 3 lists an example of combinations of the one or more undesirable motions stored in the memory 62 and situations around the vehicle 1 corresponding to the respective undesirable motions in a table format.

The undesirable motion table 621 includes one or more undesirable motions. For example, undesirable motion (1), which is an example of a first undesirable motion, is that the absolute value of lateral acceleration of the vehicle 1 exceeds an acceleration threshold X1 during travel along a curve.

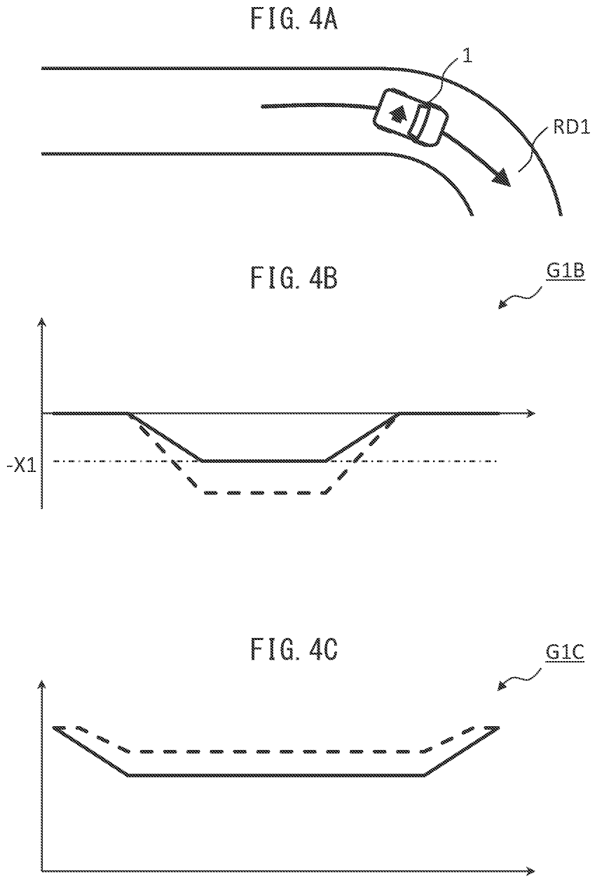

FIG. 4A schematically illustrates a situation where the first undesirable motion is detected, and FIG. 4B is a graph indicating the first undesirable motion. In the situation illustrated in FIG. 4A, the vehicle 1 is traveling on a road RD1 with a curve, causing acceleration from inside toward the outside of the curve.

The ordinate and abscissa of a graph G1B illustrated in FIG. 4B represent lateral acceleration (the right is positive) and time, respectively. A motion of the vehicle 1 that changes the value of lateral acceleration as indicated by a broken line corresponds to an undesirable motion because the absolute value of lateral acceleration exceeds the acceleration threshold X1 (the value of lateral acceleration falls below −X1). A motion of the vehicle 1 that changes the value of lateral acceleration as indicated by a solid line does not correspond to an undesirable motion because the absolute value of lateral acceleration does not exceed the acceleration threshold X1 (the value of lateral acceleration does not fall below −X1).

Referring back to FIG. 3, undesirable motion (2), which is an example of a second undesirable motion, is that the lateral space between the vehicle 1 and a nearby vehicle traveling alongside exceeds a margin threshold Y1.

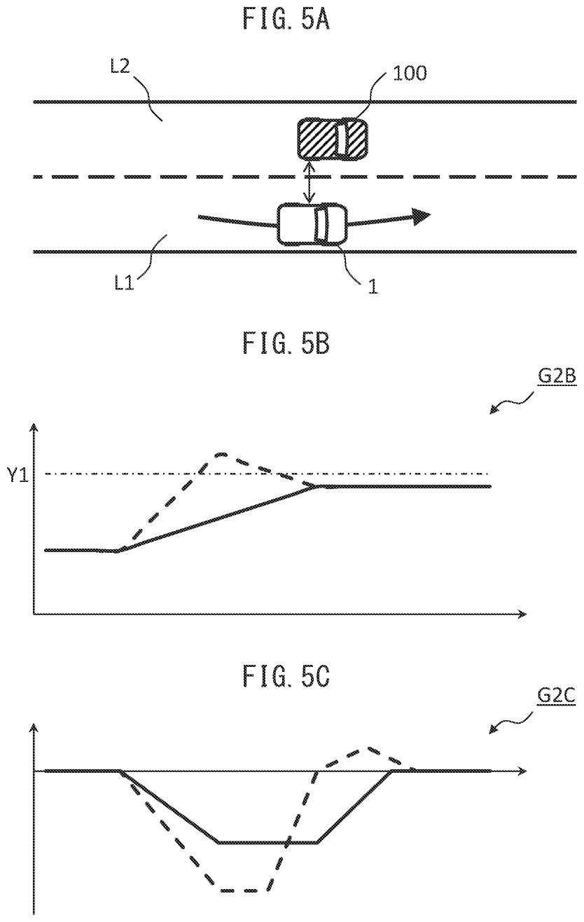

FIG. 5A schematically illustrates a situation where the second undesirable motion is detected, and FIG. 5B is a graph indicating the second undesirable motion. In the situation illustrated in FIG. 5A, a vehicle 100 is traveling alongside, near the vehicle 1, on a lane L2 adjacent to a lane L1 on which the vehicle 1 is traveling. The vehicle 1 may increase the lateral space between the vehicle 1 and the vehicle 100 when traveling near the vehicle 100.

The ordinate and abscissa of a graph G2B illustrated in FIG. 5B represent the lateral space between the vehicle 1 and an object or a feature in the vicinity of the vehicle 1 and time, respectively. A motion of the vehicle 1 that changes the value of the lateral space as indicated by a broken line corresponds to an undesirable motion, because the lateral space exceeds the margin threshold Y1. In contrast, a motion of the vehicle 1 that changes the value of the lateral space as indicated by a solid line does not correspond to an undesirable motion, because the lateral space does not exceed the margin threshold Y1.

Referring back to FIG. 3, undesirable motion (3) is that the absolute value of lateral acceleration exceeds an acceleration threshold X2, the lateral space between the vehicle 1 and an object or a feature in the vicinity of the vehicle 1 exceeds a margin threshold Y2, or the absolute value of longitudinal acceleration exceeds an acceleration threshold Z. The acceleration threshold X2 may be set to a value less than or equal to the acceleration threshold X1. The margin threshold Y2 may be set to a value less than or equal to the margin threshold Y1. The conditions of undesirable motion (3) are applicable in any situation. The conditions of an undesirable motion applicable in a specific situation may be applied prior to those of such an undesirable motion applicable in any situation. More specifically, regarding lateral acceleration in the example of the undesirable motions illustrated in the undesirable motion table 621 of FIG. 3, the condition of undesirable motion (1) is applied to travel along a curve, whereas the conditions of undesirable motion (3) are applied in the other situations.

Regarding longitudinal acceleration, the memory 62 may store two different undesirable motions specified with a positive acceleration threshold for motion at acceleration and a negative acceleration threshold for motion at deceleration, respectively.

Referring back to FIG. 2, the memory 62 further stores various application programs, e.g., a computer program for controlling travel, which is for causing the travel controller 6 to execute a method for controlling travel.

The processor 63, which is an example of a control unit, includes one or more processors and a peripheral circuit thereof. The processor 63 may further include another operating circuit, such as a logic-arithmetic unit, an arithmetic unit, or a graphics processing unit.

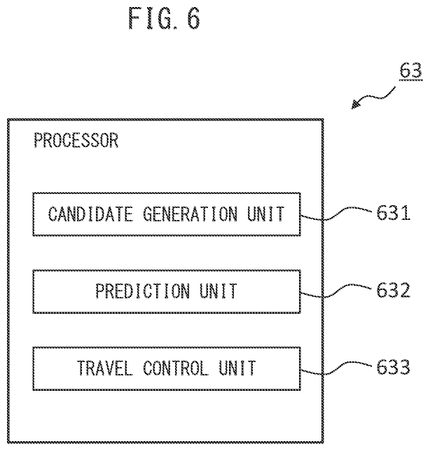

FIG. 6 is a functional block diagram of the processor 63 included in the travel controller 6.

As its functional blocks, the processor 63 of the travel controller 6 includes a candidate generation unit 631, a prediction unit 632, and a travel control unit 633. These units included in the processor 63 are functional modules implemented by a computer program executed by the processor 63. The computer program for achieving the functions of the units of the processor 63 may be provided in a form recorded on a computer-readable portable storage medium, such as a semiconductor memory, a magnetic medium, or an optical medium. Alternatively, the units included in the processor 63 may be implemented in the travel controller 6 as separate integrated circuits, microprocessors, or firmware.

The candidate generation unit 631 obtains a surroundings image from the front camera 2 via the communication interface 61, and generates a candidate parameter set including one or more parameters for controlling travel of the vehicle 1, based on input data including the surroundings image. In addition to a surroundings image, the input data may include data indicating the condition of travel of the vehicle 1, such as speed data of the vehicle 1 obtained from a speed sensor (not illustrated) via the communication interface 61 and orientation data of the vehicle 1 obtained from an orientation sensor (not illustrated).

The candidate generation unit 631 identifies one or more parameters by inputting the obtained input data into a classifier that has been trained to output one or more parameters, based on input data, and determines the one or more parameters as a candidate parameter set. The one or more parameters include a parameter for controlling a travel mechanism (not illustrated) that accelerates, decelerates, and steers the vehicle 1. The travel mechanism includes, for example, an engine or a motor for powering the vehicle 1, brakes for decelerating the vehicle 1, and a steering mechanism for steering the vehicle 1. A parameter for controlling the travel mechanism is, for example, target vehicle speed, acceleration, or the amount of steering.

The classifier may be, for example, a neural network including, from the input side toward the output side, a convolutional neural network (CNN) including convolution layers connected in series as well as fully-connected layers. A neural network that has been trained in accordance with a predetermined training technique, such as backpropagation, using training data, which is input data including a large number of surroundings images and parameters provided with the travel mechanism at timings corresponding to the input data, operates as a classifier configured to output parameters based on input data. Together with the parameters, the classifier may output a confidence score indicating the reliability of the one or more parameters outputted based on input data. The classifier may output multiple parameter sets each including one or more parameters. For example, the classifier outputs multiple parameter sets each having a confidence score greater than or equal to a predetermined threshold.

As the classifier may be used a neural network including, from the input side toward the output side, a CNN, a recurrent neural network (RNN), and fully-connected layers.

The candidate generation unit 631 may execute pre-processing, such as resizing or normalization, on a surroundings image obtained from the front camera 2 via the communication interface 61, and use the resulting data as the input data.

The prediction unit 632 predicts a future motion of the vehicle 1 under control of travel with the candidate parameter set.

The prediction unit 632 reads an area in the memory 62 storing the candidate parameter set generated by the candidate generation unit 631 to obtain the candidate parameter set. The prediction unit 632 reads an area in the memory 62 storing parameters used for controlling the travel mechanism to obtain parameters used for current control of the vehicle 1. The prediction unit 632 obtains speed data of the vehicle 1 from the speed sensor (not illustrated) via the communication interface 61, and orientation data of the vehicle 1 from the orientation sensor (not illustrated), as the condition of travel of the vehicle 1.

The prediction unit 632 obtains future acceleration and the amount of future steering included in the candidate parameter set, and estimates future vehicle speed, based on the future acceleration and the current vehicle speed among the parameters used for current control of the vehicle 1. The prediction unit 632 also estimates lateral acceleration, which is an example of a value indicating a future motion of the vehicle 1, based on the future vehicle speed and the amount of future steering of the vehicle 1.

Further, the prediction unit 632 obtains a depth map from the side sensors 3 via the communication interface 61, and identifies the shortest of the distances indicated in the obtained depth map as the current lateral space. The prediction unit 632 estimates a lateral space, which is an example of a value indicating a future motion of the vehicle 1, based on the current lateral space as well as the future acceleration and the amount of future steering included in the candidate parameter set.

The prediction unit 632 may identify the position of a vehicle traveling alongside from a surroundings image obtained from the front camera 2, and estimate a future lateral space, based on the identified position of the vehicle traveling alongside and the amount of future steering. For example, the prediction unit 632 inputs a surroundings image into a classifier that has been trained to detect a region corresponding to an object, such as a vehicle, from an image, and identifies a region corresponding to a vehicle traveling alongside in the surroundings image. The prediction unit 632 estimates the direction of the vehicle traveling alongside with respect to the vehicle 1, by referring to capturing parameters of the front camera 2 stored in the memory 62, such as the angle of view and the orientation with respect to the vehicle 1. The prediction unit 632 can determine the distance from the vehicle 1 to the vehicle traveling alongside and estimate a lateral space, by comparing the size of a standard vehicle stored in the memory 62 with that of the region corresponding to the vehicle traveling alongside identified in the surroundings image.

The travel control unit 633 transmits a control signal to the travel mechanism of the vehicle 1 via the communication interface 61 to control travel of the vehicle 1. First, the travel control unit 633 determines whether the future motion of the vehicle 1 predicted for the candidate parameter set corresponds to one of the one or more undesirable motions stored in the memory 62. When the future motion of the vehicle does not correspond to any of the one or more undesirable motions, the travel control unit 633 controls travel of the vehicle 1 with the candidate parameter set. However, when the future motion of the vehicle corresponds to one of the one or more undesirable motions, the travel control unit 633 controls travel of the vehicle 1 without the candidate parameter set.

The travel control unit 633 reads an area in the memory 62 storing the future motion of the vehicle 1 predicted by the prediction unit 632 to obtain the future motion of the vehicle 1. The travel control unit 633 reads the one or more undesirable motions stored in the memory 62.

Further, the travel control unit 633 identifies the situation of travel of the vehicle 1. For example, the travel control unit 633 receives a positioning signal from the GNSS receiver 4 via the communication interface 61, and obtains map information around the position of the vehicle indicated by the received positioning signal from the storage device 5. Based on the obtained map information, the travel control unit 633 determines whether the vehicle 1 is traveling along a curve. Further, the travel control unit 633 obtains a depth map from the side sensors 3 via the communication interface 61, and determines the presence or absence of a vehicle traveling alongside, based on the obtained depth map.

The travel control unit 633 determines whether the obtained future motion of the vehicle 1 corresponds to one of the read-out one or more undesirable motions. Specifically, the travel control unit 633 may first identify undesirable motions corresponding to the situation of travel of the vehicle 1 from the read-out one or more undesirable motions, and then determine whether the obtained future motion of the vehicle 1 corresponds to one of the identified undesirable motions.

When the future motion of the vehicle 1 does not correspond to any of the one or more undesirable motions, the travel control unit 633 transmits a control signal indicating the candidate parameter set to the travel mechanism of the vehicle 1 via the communication interface 61. On the other hand, when the future motion of the vehicle 1 corresponds to one of the one or more undesirable motions, the travel control unit 633 transmits a control signal that does not indicate the candidate parameter set to the travel mechanism. Specifically, as the control signal that does not indicate the candidate parameter set, the travel control unit 633 may transmit, to the travel mechanism, a parameter set in which at least one of the one or more parameters included in the candidate parameter set is modified so that the future motion of the vehicle 1 does not correspond to any of the one or more undesirable motions. The travel control unit 633 can determine whether the future motion of the vehicle 1 predicted by the prediction unit 632 for the modified parameter set corresponds to one of the one or more undesirable motions. Thus, the travel control unit 633 repeats modification of parameters and prediction of motions until the future motion for the modified parameter set no longer corresponds to any of the one or more undesirable motions.

First, an example of control of travel corresponding to the first undesirable motion will be described. Assume that a motion indicated by the broken line in the graph G1B illustrated in FIG. 4B is predicted for a candidate parameter set generated in the situation illustrated in FIG. 4A. Since the motion indicated by the broken line corresponds to an undesirable motion, as described above, the travel control unit 633 controls travel of the vehicle 1 without the candidate parameter set.

FIG. 4C is a graph of a parameter corresponding to the first undesirable motion.

In a graph G1C illustrated in FIG. 4C, the ordinate and abscissa represent target vehicle speed and time, respectively. The broken line represents target vehicle speed included in the candidate parameter set whereas the solid line represents target vehicle speed modified by the travel control unit 633. It is predicted that the modified parameter set will result in the vehicle 1 moving as indicated by the solid line in the graph G1B illustrated in FIG. 4B. Since the motion indicated by the solid line in the graph G1B does not correspond to an undesirable motion, as described above, the travel controller 6 can control travel of the vehicle 1 appropriately.

Next, an example of control of travel corresponding to the second undesirable motion will be described. Assume that a motion indicated by the broken line in the graph G2B illustrated in FIG. 5B is predicted for a candidate parameter set generated in the situation illustrated in FIG. 5A. Since the motion indicated by the broken line corresponds to an undesirable motion, as described above, the travel control unit 633 controls travel of the vehicle 1 without the candidate parameter set.

FIG. 5C is a graph of a parameter corresponding to the second undesirable motion.

In a graph G2C illustrated in FIG. 5C, the ordinate and abscissa represent the amount of steering and time, respectively. The broken line represents the amount of steering included in the candidate parameter set whereas the solid line represents the amount of steering modified by the travel control unit 633. It is predicted that the modified parameter set will result in the vehicle 1 moving as indicated by the solid line in the graph G2B illustrated in FIG. 5B. Since the motion indicated by the solid line in the graph G2B does not correspond to an undesirable motion, as described above, the travel controller 6 can control travel of the vehicle 1 appropriately.

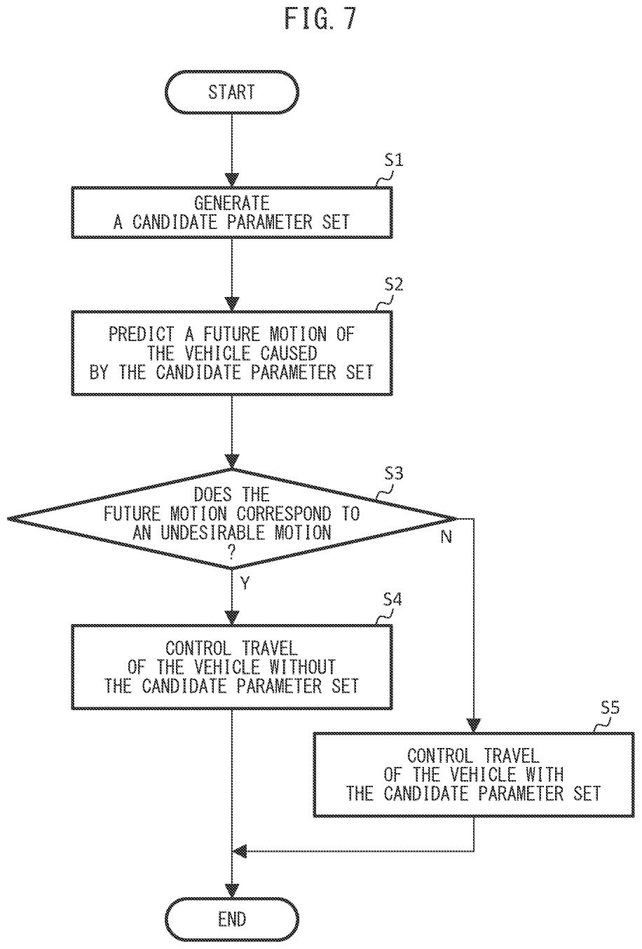

FIG. 7 is a flowchart of a travel control process. During travel of the vehicle 1 by autonomous driving, the processor 63 of the travel controller 6 repeatedly executes the travel control process described below at predetermined intervals (e.g., intervals of 1/10 seconds).

First, the candidate generation unit 631 of the processor 63 of the travel controller 6 generates a candidate parameter set by inputting input data including a surroundings image obtained by the front camera 2 into a classifier (step S1).

The prediction unit 632 of the processor 63 predicts a future motion of the vehicle 1 under control of travel with the candidate parameter set (step S2).

The travel control unit 633 of the processor 63 determines whether the future motion of the vehicle 1 predicted for the candidate parameter set corresponds to one of the one or more undesirable motions (step S3).

When the future motion of the vehicle corresponds to one of the one or more undesirable motions (Yes in step S3), the travel control unit 633 controls travel of the vehicle 1 without the candidate parameter set (step S4) and terminates the travel control process.

When the future motion of the vehicle does not correspond to any of the one or more undesirable motions (No in step S3), the travel control unit 633 controls travel of the vehicle 1 with the candidate parameter set (step S5) and terminates the travel control process.

By executing the travel control process in this way, the travel controller 6 can control motion of the vehicle appropriately.

It should be noted that those skilled in the art can make various changes, substitutions, and modifications without departing from the spirit and scope of the present disclosure.

What is claimed is:

1. A travel controller comprising:
a memory configured to store one or more undesirable motions of a vehicle that are to be avoided; and
a processor configured to
generate a candidate parameter set including one or more parameters for controlling travel of the vehicle by inputting input data into a classifier that has been trained to output the one or more parameters in response to input of the input data, the input data including a surroundings image obtained by a camera configured to take pictures of surroundings of the vehicle,
predict a future motion of the vehicle under control of travel with the candidate parameter set,
control travel of the vehicle with the candidate parameter set when the future motion of the vehicle predicted for the candidate parameter set does not correspond to any of the one or more undesirable motions, and
control travel of the vehicle without the candidate parameter set when the future motion of the vehicle predicted for the candidate parameter set corresponds to one of the one or more undesirable motions.

2. The travel controller according to claim 1, wherein
the processor generates candidate parameter sets each including the one or more parameters, in the generation, and
in the case where the future motion of the vehicle predicted for at least one of the generated candidate parameter sets corresponds to one of the one or more undesirable motions,
and where the future motion of the vehicle predicted for the other candidate parameter sets does not correspond to any of the one or more undesirable motions, the processor controls travel of the vehicle with one of the other candidate parameter sets, in the control of travel.

3. A method for controlling travel executed by a travel controller configured to control travel of a vehicle, the method comprising:
generating a candidate parameter set including one or more parameters for controlling travel of the vehicle by inputting input data into a classifier that has been trained to output the one or more parameters in response to input of the input data, the input data including a surroundings image obtained by a camera configured to take pictures of surroundings of the vehicle;
predicting a future motion of the vehicle under control of travel with the candidate parameter set;
controlling travel of the vehicle with the candidate parameter set when the future motion of the vehicle predicted for the candidate parameter set does not correspond to any of one or more undesirable motions of the vehicle that are to be avoided, the undesirable motions being stored in a memory; and
controlling travel of the vehicle without the candidate parameter set when the future motion of the vehicle predicted for the candidate parameter set corresponds to one of the one or more undesirable motions.

4. A non-transitory computer-readable medium storing a computer program for controlling travel, the computer program causing a computer mounted on a vehicle to execute a process comprising:
generating a candidate parameter set including one or more parameters for controlling travel of the vehicle by inputting input data into a classifier that has been trained to output the one or more parameters in response to input of the input data, the input data including a surroundings image obtained by a camera configured to take pictures of surroundings of the vehicle;
predicting a future motion of the vehicle under control of travel with the candidate parameter set;
controlling travel of the vehicle with the candidate parameter set when the future motion of the vehicle predicted for the candidate parameter set does not correspond to any of one or more undesirable motions of the vehicle that are to be avoided, the undesirable motions being stored in a memory; and
controlling travel of the vehicle without the candidate parameter set when the future motion of the vehicle predicted for the candidate parameter set corresponds to one of the one or more undesirable motions.
